(19) United States
(12) Patent Application Publication
(10) Pub. No.: US 2005/0233639 A1
(43) Pub. Date: Oct. 20, 2005

(54) Electrical plug-in connector

(75) Inventors: Christoph Blosch, Bubenreuth (DE); Heinz Ungermann, Linsengericht (DE); German Kager, Oberaurach-Kirchaich (DE); Michael Ziegmann, Bamberg (DE); Wolfram Hohmann, Bamberg (DE)

Correspondence Address: LERNER AND GREENBERG, PA, P O BOX 2480, HOLLYWOOD, FL, 33022-2480, US

(73) Assignee: Wieland Electric GmbH

(21) Appl. No.: 11/098,354

(22) Filed: Apr. 4, 2005

Related U.S. Application Data
(63) Continuation of application No. PCT/EP03/10763, filed on Sep. 27, 2003.

(30) Foreign Application Priority Data
Oct. 4, 2002 (DE) 102 46 450.2

(51) Int. Cl. H01R 13/73

(52) U.S. Cl. 439/587

(57) ABSTRACT

An electrical plug-in connector is in the form of a cable plug connector or a device connector plug. A particularly reliable and tightly-sealed connector may be achieved, whereby the plug-in connector is disclosed, and contains a connector mechanism, which is self-closing on bringing the parts for connection together. The plug-in connector further contains a radial seal for sealing the parts connected together.

### CROSS-REFERENCE TO RELATED APPLICATION

This is a continuing application, under 35 U.S.C. § 120, of copending international application No. PCT/EP2003/010763, filed Sep. 27, 2003, which designated the United States; this application also claims the priority, under 35 U.S.C. § 119, of German patent application No. 102 46 450.2, filed Oct. 4, 2002; the prior applications are herewith incorporated by reference in their entirety.

### BACKGROUND OF THE INVENTION

### FIELD OF THE INVENTION

The invention relates to an electrical plug-in connector, in particular in the form of a cable plug-in connector or a device connection plug.

In order to achieve a particularly good seal, it is known to insert sealing rings in the contact-protection sleeves surrounding the pin contacts of a plug-in connector. The sealing rings act as axial seals, i.e. are compressed when the socket and plug parts are connected. In this case, sealing forces are introduced into the plug-in connection. In order to ensure a permanent seal, for this reason, materials, which have a particularly high strength are always required for producing the plug-in connector or additional securing elements are always required for securing the plug-in connection.

### SUMMARY OF THE INVENTION

It is accordingly an object of the invention to provide an electrical plug-in connector that overcomes the above-mentioned disadvantages of the prior art devices of this general type, which closes in a particularly reliable and sealing manner.

With the foregoing and other objects in view there is provided, in accordance with the invention, an electrical plug-in connector. The connector contains parts to be connected to each other for forming a plug/socket connection having plug-in connectors. A connection mechanism closes automatically when the parts are joined together. A contact-protection sleeve is provided and a radial seal is disposed on the contact-protection sleeve, for sealing the parts connected to one another, in a region of overlap between the plug-in connectors connected to one another.

According to the invention, the plug-in connector has a connection mechanism, which closes automatically when the parts to be connected are joined together. Furthermore, the plug-in connector has a radial seal for the purpose of sealing the parts, which are connected to one another. The connection mechanism is configured to connect the plug-in connector to a further plug-in connector such that the radial seal is disposed in the region of overlap when the plug and the socket part are plugged together. When the socket part and the plug part are connected, the contact-protection sleeves, which are fitted on the socket part and which surround the plug sockets, can be pushed into corresponding contact-protection sleeves which surround the pin contacts on the plug part with a spacing. The radial seal is advantageously disposed in the region of the contact-protection sleeve, preferably on the contact-protection sleeve of the plug part.

One basic principle of the invention relates to replacing the axial seal, which has been used to date with a radial seal. The sealing forces thus act radially, i.e. in the direction of the circumference of the plug-in connector and no longer in the axial connection direction of the plug-in connector. The radial seal therefore acts without sealing forces needing to be introduced into the plug-in connection. In other words, the sealing forces need no longer be applied through the plug-in connection or through additional securing apparatuses. This solution makes it possible to simplify the configuration of the plug-in connector. In particular, it may be manufactured completely from plastic without additional securing apparatuses being required, since only the grip of the plug-in connection, but no longer the sealing forces, need to be protected. The plug-in connectors obtained in this manner with force-free locking or latching are not only simple in design terms, but also have a particularly good seal, with the result that, for example, the requirements in accordance with IP 67 are fulfilled. A simple configuration of the plug-in connector is likewise achieved owing to the positive locking. In a very favorable case, only two parts are required for the connection, which can be plugged onto one another without using a tool. In this case, the plug-in connector according to the invention may be, for example, a cable plug-in connector or a device connection plug.

In order to produce the plug-in connection, in this case a locking tongue is preferably used which connects the plug and the socket part to one another. Such a locking tongue is known, for example, from the German patent DE 34 40 043 C2, in particular from patent claims 1 to 4 therein. Since the locking is force-free owing to the use of a radial seal, it is sufficient to attach a single locking tongue. Despite the asymmetrical locking, a secure and tight connection is possible since there are no longer any counter-forces acting on the locking.

In order to mount the device connection plug on a device wall, for example a luminaire housing, the plug has a mounting element, for example, in the form of a stop collar. An axial seal is fitted to the mounting element, by which seal the stop element bears against the housing wall surrounding the mounting opening. Furthermore, the plug-in connector bears a thread for the purpose of securing the stop collar on the housing wall by a screw connection.

In one development of the invention, a two-part device connection plug is proposed which requires a much smaller housing bushing. Accordingly, the electrical plug-in connector contains an adapter element and a contact carrier, which can be connected to the adapter element. For this purpose, a specially configured adapter element having a bushing connection piece is used, with the result that the device connection plug can be used even in the case of housing bushings which have been narrowed to the dimensions of the cable diameter plus the housing wall thickness. The adapter element can be combined with the plug or socket contact carriers of the plug-in connector. One particular advantage is the fact that it is not necessary for the user to change existing housing holes. Second, in each case only one new adapter connection piece needs to be developed and produced, since it can be combined with already existing modules.

If the plug-in connector is in the form of a cable plug-in connector, it has an automatically closing connection mechanism for the purpose of connecting the contact carrier of the plug-in connector to a strain-relief device and a radial seal for the purpose of sealing the parts, which are connected to one another. In another embodiment, the strain-relief device can simply be pushed onto the contact carrier. This considerably simplifies assembly. In this case, the strain-relief device is preferably pushed onto the contact carrier axially, i.e. in the longitudinal direction of the plug. The preferably sleeve-like strain-relief device is in this case, in accordance with a further embodiment of the invention, fixed to the contact carrier by a latching connection. The largely preassembled nature in which, for example, the strain-relief device and the contact carrier have already been connected to one another, makes the plug-in connector easy to use and easy to install.

The radial seal, which is provided for purpose of sealing the connection, is disposed in the region of overlap between the strain-relief device and the contact carrier. The strain-relief device, which has been pushed onto the contact carrier, is preferably fixed with the aid of a union nut, which is fitted at one end. The union nut at the same time serves the purpose of providing a further seal with respect to the cable emerging from the plug-in connector.

Even the embodiment as a cable plug-in connector may have, at one end, the above-described connection mechanism for the purpose of connecting a complementary plug part. The contact carriers of cable plug-in connectors and device connection plugs preferably have an identical configuration in this regard.

The contact carrier has a contact region, which is disposed opposite the plug or socket face, for the purpose of connecting the conductors. The connection region preferably contains so-called push-in contacts, into which the conductors can be inserted in a simple manner. The wiring complexity is thus very low. The push-in contacts are in this case, in particular, in the form of spring-force terminals. However, screw, crimping, soldered or insulation displacement connections may also be used, for example. It is particularly advantageous if spring-force terminals are equipped with a double connection for two conductor ends per pole. In this case, the strain-relief device is preferably configured such that it ensures the connection of two round cables parallel to one another in one plug-in connector.

It is particularly advantageous if the connection mechanism can be opened only using an actuating tool. This fulfills the requirements for re-connectable service plug-in connectors in accordance with EN 61535. With the particular configuration of the radial seal, in particular when release takes place by use of a tool, there is initially a form of pre-release of the plug-in connection. As a result, the frictional forces, which are then still to be overcome, of the radial seal between the connection parts, are no longer so large. It is thus possible for the connection to be released particularly easily.

In a further advantageous embodiment of the invention, the plug-in connector contains a corresponding opener for the purpose of unlocking the connection mechanism. It is thus possible to use a plug-in connector, which can only be opened using a tool even in cases where plug-in connectors, which need to be opened by hand are usually used, without this resulting in additional complexity for the user. In this case, the opener is connected to the plug-in connector such that it can be released, preferably so as to form a latching or a snap connection. Furthermore, suitable encoding measures can be used to ensure that the opener can only be mounted on those plug-in connectors for which the use of the opener is desired.

A particularly simple but nevertheless reliable actuation of the connection mechanism is possible by an opener. The opener has a release element for the purpose of unlocking the connection mechanism, which is fitted to an actuating element, which can preferably be deflected by hand. Such an opener can be of integral construction and can be made completely from plastic, as a result of which it can be produced in a particularly cost-effective manner.

In one further preferred embodiment of the invention, the contact-protection sleeves surrounding the plug-in contacts are configured such that, in addition to protection against rotation by the use of corresponding encoding elements, protection against plugging is also achieved as regards plugging together pairs of plugs, which are not associated with one another.

Other features which are considered as characteristic for the invention are set forth in the appended claims.

Although the invention is illustrated and described herein as embodied in an electrical plug-in connector, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1-3 are diagrammatic, perspective views of a plug part of a device connection plug according to the invention;

FIGS. 4-6 are diagrammatic, perspective views of a socket part of the device connection plug;

FIGS. 7-9 are diagrammatic, perspective views of a plug part of a cable plug-in connector;

FIG. 10 is a diagrammatic, perspective view of a strain-relief device for the cable plug-in connector;

FIGS. 11-13 are diagrammatic, perspective views of a socket part of the cable plug-in connector;

FIG. 14 is a diagrammatic, perspective view of an opener for a connection mechanism;

FIG. 15 is a diagrammatic, perspective view of a socket part having a locking tongue;

FIG. 16 is a diagrammatic, perspective view of the socket part having an opener snapped on;

FIG. 17 is a diagrammatic, plan view of the plug-in face of a plug with encoding and protection against rotation;

FIG. 18 is a diagrammatic, plan view of the plug-in face of a socket relating to the plug shown in FIG. 17;

FIGS. 19A-19M are schematic illustrations of the possible encodings in the case of the plug shown in FIG. 17; and

FIGS. 20-21 are diagrammatic, sectional views of further exemplary embodiments.

### DESCRIPTION OF THE PREFERRED EMBODIMENTS

Referring now to the figures of the drawing in detail and first, particularly, to FIGS. 1-3 thereof, there is shown an embodiment of a plug-in connector according to the invention as a device connection plug. Here, a three-pole (N, L, ground) round plug-in connector 1, in the form of a plug part, is shown which has already been fitted in a mounting opening of a device wall 2. The plug-in connector according to the invention, however, may also be configured to have, for example, five poles or any desired number of poles. The three plug pins 5, which are disposed parallel to one another, are each surrounded by a contact-protection sleeve 6, which protrudes beyond the pin contacts, on a front end side 3 of a cylindrical contact carrier 4 of the plug-in connector 1. The contact-protection sleeves 6 are surrounded by a casing 7, which is generally triangular in cross section and, which is integrally formed on the contact carrier 4 of the plug-in connector 1.

For mounting on the device wall 2, the contact carrier 4 has a circumferential stop collar 8. In order to seal the plug-in connector 1 to the housing wall 2, an axial seal 9, for example in the form of a sealing ring, which is clad on one side with an adhesive film, is fitted to the stop collar 8. The plug-in connector 1 is inserted into the housing opening from a housing interior 10 and is fixed externally on the device wall 2 with the aid of a fixing nut 11. When the fixing nut 11 is tightened, the sealing ring 9 is then compressed, and seals the mounting opening. A corresponding external thread 12 is fitted to the contact carrier 4 in the region of the stop collar 8.

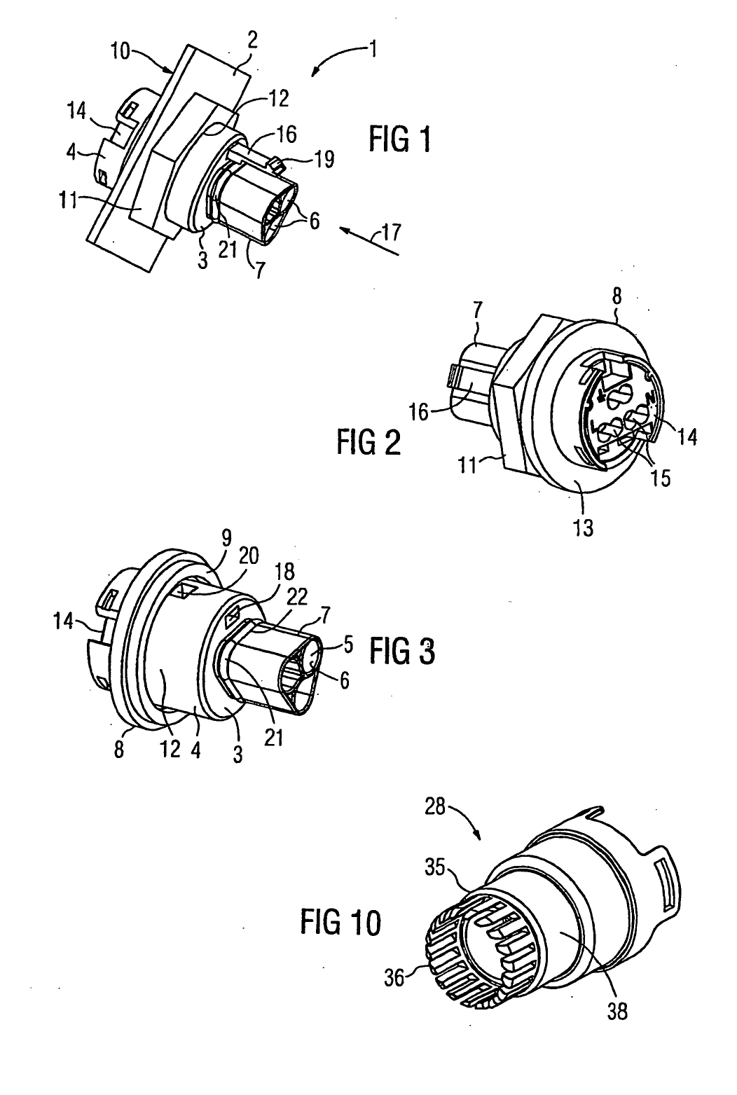

As depicted in FIG. 2, which illustrates the plug-in connector 1 without the housing wall, a contact region 14 is provided on a rear end side 13, which is opposite the front end side 3, of the plug-in connector 1 for the purpose of connecting the non-illustrated conductors. The connection region 14 has push-in contacts 15 in the form of spring-force terminals. It is thus possible, for example, to connect single-wire or finely stranded conductors having a cross-sectional connection area of 0.75 to 2.5 mm*mm. Contacts 15 are in this case in the form of twin contacts, with the result that in each case two conductor ends can be connected to one pole.

In order to form a reliable connection to the corresponding socket part, a locking tongue 16 is provided which can be inserted into a longitudinal shaft 18, which extends in the plug-in direction 17, in the plug housing 4, and whose locking hook 19, which is fitted at one end, engages in a correspondingly provided locking window 20 to provide a secure fixing, see FIG. 3, which shows the plug-in connector 1 without a nut and locking tongue. The locking tongue 16 can in this case be plugged in either loosely or else as an already preassembled component on the plug or socket part. However, it is also possible for the locking tongue 16 to be in the form of an integral component of the contact carrier 4.

Directly at the foot of the covering 7, a radial seal 21 is applied around the external covering 7 of the contact-protection sleeves 6. The radial seal 21 extends into a correspondingly provided accommodating groove 22. In this case, a conventional 0-ring may be used as the radial seal 21, which in this case assumes the triangular form of the protective covering 7 when it is applied.

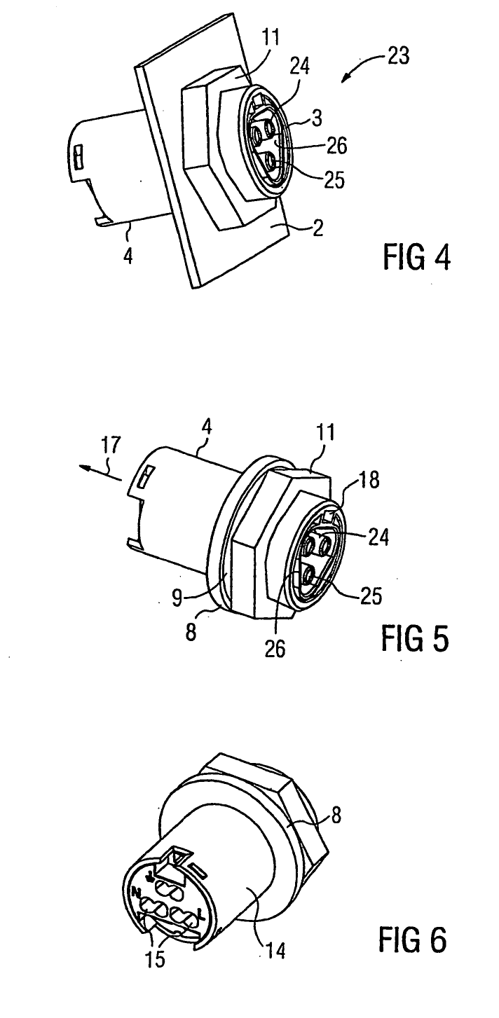

FIG. 4 shows a socket part 23, which corresponds to the just-described plug part 1, of a round plug-in connector. The socket part 23 can also be mounted in the housing opening of the device wall 2 with the aid of a fixing nut 11. In order to seal the plug-in connector 23 to the device wall 2, in turn an axial seal is provided on the stop collar 8. The connection region 14, which is fitted at the rear, is provided with twin connections 15 in the form of spring-force terminals, just as in the case of the plug part 1.

The plug face lying on the front side 3 in turn has three contact-protection sleeves 24, which surround the three contact sockets 25 (N, L, ground). A covering 26, which is in turn essentially triangular in cross section, is disposed around the contact-protection sleeves 24. However, the protective casing 26, in contrast to the above-described plug part 1, does not protrude beyond the front end side 3 of the contact carrier 4, but ends with it. Even the socket part 23 has a longitudinal shaft 18, which extends in the plug-in direction 17, for the purpose of accommodating a locking tongue and corresponding locking windows for latching the latching hooks.

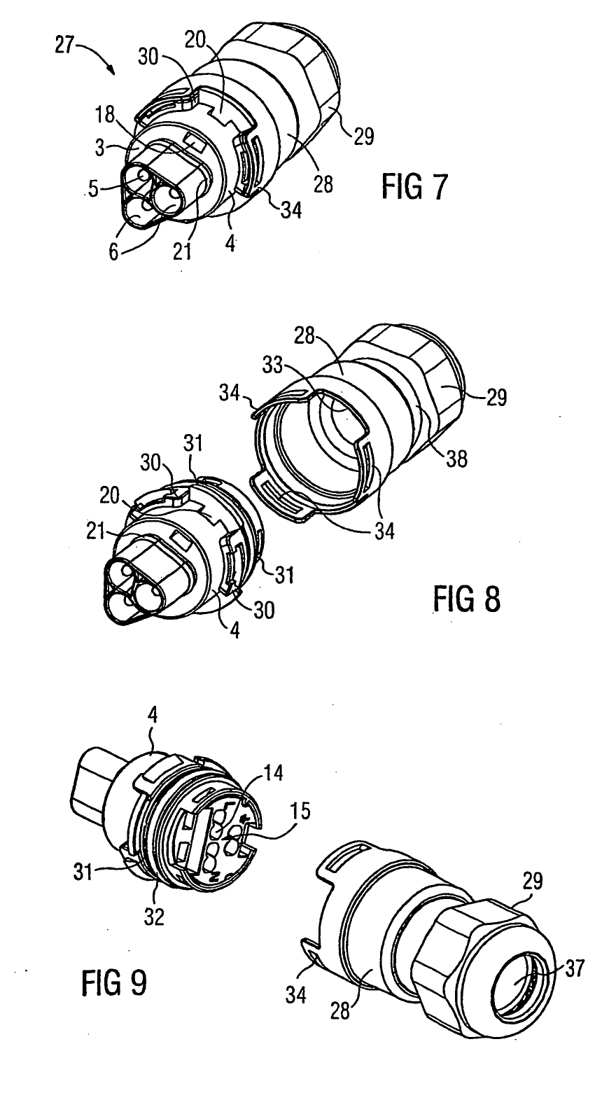

In a further embodiment of the invention, the plug-in connector is in the form of a cable plug-in connector. In FIGS. 7 to 9, here in turn a three-pole embodiment of a corresponding plug part 27 is shown. A strain-relief device 28, which is fixed with the aid of a union nut 29, is fitted to the rear side, which lies opposite the end side 3 of the contact carrier 4. The end side 3 having the plug contacts 5, the contact-protection sleeves 6 and the radial seal 21 as well as the corresponding locking elements 18, 20 is in this case of identical configuration to the above-described device connection plug 1, 23. However, the plug-in connector housing 4 now has additional latching elements in the form of latching hooks 30 for the purpose of producing a latching or snap connection to the strain-relief device 28.

In order to seal the connection between the contact carrier 4 and the strain-relief device 28, a circumferential radial seal 31 is provided on the contact carrier 4 and is inserted in a correspondingly circumferential groove 32 and held therein. When the strain-relief device 28 is latched onto the contact carrier 4, the radial seal 31 is then located in the region of overlap and seals the two parts 4, 28 with respect to one another.

The strain-relief device 28 which is in the form of a kind of sleeve (see FIG. 10) has, on its front end side 33, three latching recesses 34, which are disposed offset with respect to one another and which are in the form of grips. When the strain-relief device 28 is pushed axially onto the contact carrier 4, in this case three latching elements 30, which are disposed symmetrically at the rear on the circumference of the contact carrier 4, engage in the latching recesses 34 in the strain-relief device 28.

The strain-relief device 28 tapers, starting from its front side, in the direction of its rear side with a plurality of steps (see FIG. 10) and has, at its rear end 35, a lamella-like holding apparatus 36 for the purpose of fixing the non-illustrated cable. A cable seal 37 lies in the strain-relief device 28 for the purpose of additionally sealing the plug-in connector 27 to the cable to be connected. The strain-relief device 28 is fixed with the aid of a fixing nut 29, which is screwed onto the rear of the strain-relief device 28. For this purpose, the strain-relief device 28 has a corresponding external thread. The fixing nut 29, just as the fixing nut 11 for the purpose of fixing the plug-in connector 1, 23 to a device wall, may be provided with a mechanism which prevent the possibility of screwing by hand. The mechanism may be, for example, ratchet-like latching hooks.

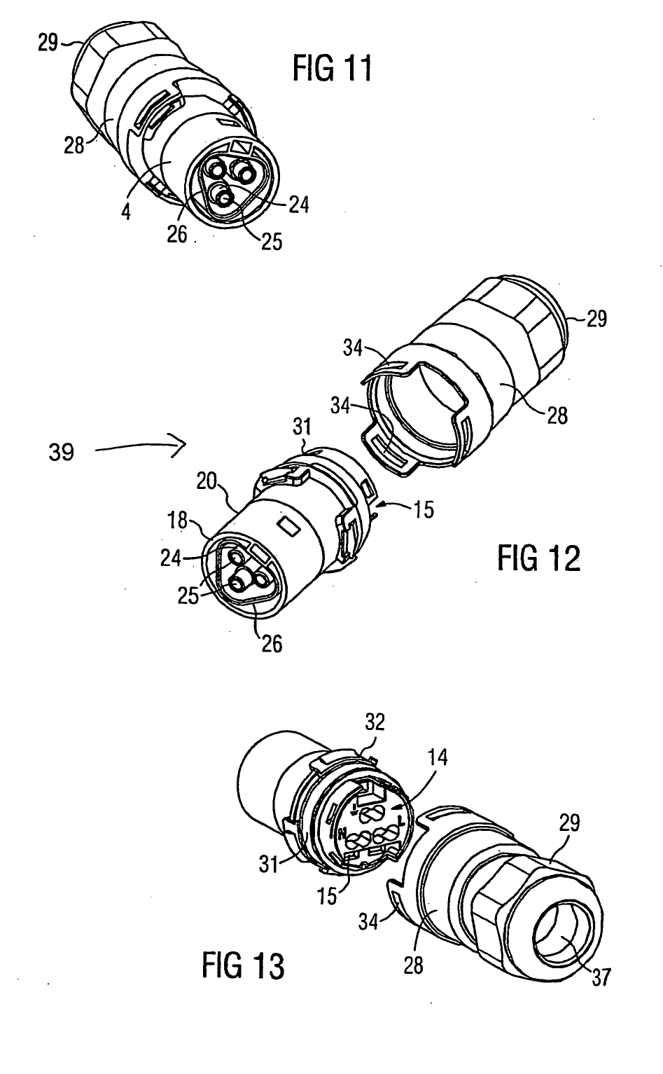

For the purpose of connecting the plug-in connector 27, first the strain-relief device 28 and the cable seal 37 are pulled over the cable. Then, the cables, from which insulation has been stripped, are connected to the spring-force terminals 15, and the strain-relief device 28 is connected to the contact carrier 4 by being latched on axially. FIGS. 11 to 13 show a corresponding socket part 39 of the cable plug-in connector.

The plug-in connectors 1, 23, 27, 39 described can be plugged to one another so as to form socket/plug combinations. It is thus possible, for example, for the plug part 27 (shown in FIG. 7) of the cable plug-in connector to be connected to the socket part 23 (shown in FIG. 4) of a device connection plug etc. When the socket and plug parts are connected, the respective contact-protection sleeves 7, 26 are pushed one inside the other. In this case, the inner side of the protective covering 26 of the socket part 23, 39 then bears against the outer side of the covering 7 of the plug part 1, 27, with the result that the radial seal 21 fitted to the plug part 1, 27 seals the socket and plug parts with respect to one another.

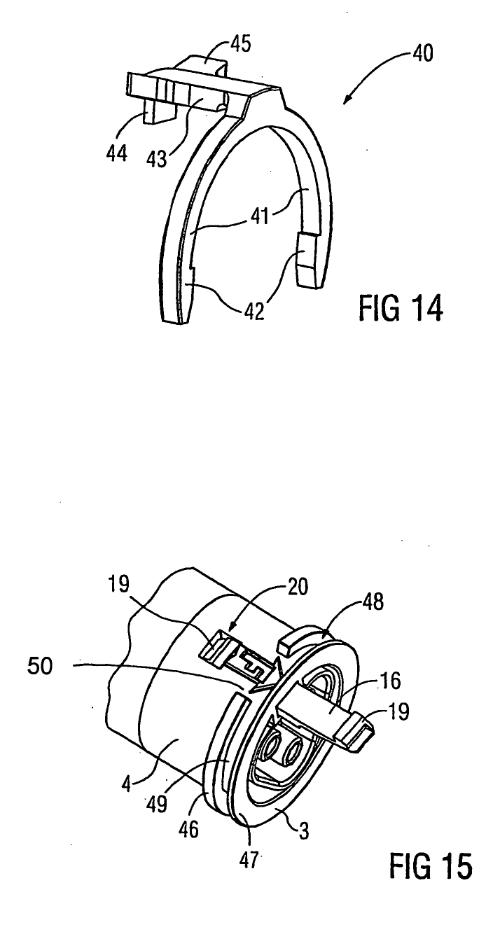

An opener 40 for the purpose of opening the locking is shown in FIG. 14. The opener 40 has an at least semi-circular ring segment 41 for the purpose of fixing it to the contact carrier 4, snap hooks 42 being fitted to the ends of the ring segment 41. A release knob 44 is fitted to the ring segment 41 via a resilient web 43. An actuating surface 45 is fitted to that side of the web 43, which lies opposite the release knob 44. For the purpose of fixing the opener 40 to the contact carrier 4, the contact carrier 4, as illustrated in FIG. 15, has an accommodating groove 48, which is formed on its front end side by an inner ring 46 and an outer ring 47. When mounted, the inner and outer rings 46, 47 at the same time serve the purpose of absorbing the forces produced on actuation of the opener 40.

The accommodating groove 48 has at least two latching recesses 49 for the purpose of accommodating the snap hooks 42 of the opener 40. The inner ring 46 has an aperture 50 in the region of the locking window 20 for the purpose of accommodating the opener web 43, which, when mounted, extends from the accommodating groove 48 to the locking window 20.

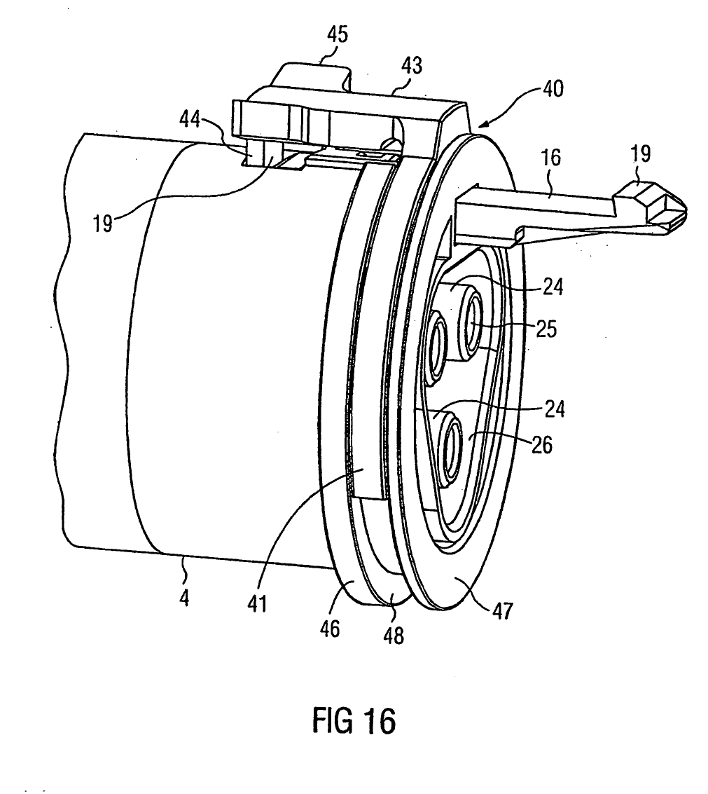

As illustrated in FIG. 16, the opener 40 is in the latched state disposed on the contact carrier 4 such that the release knob 44 points into the locking window 19 without it coming into contact with the locking tongue 16, 19. On actuation of the opener 40, by the web 43 being deflected from its rest position, for example, owing to the pressure of a finger on the actuating surface 45, the relief knob 44 moves into the locking window 19 and pushes the latching hook 19 of the locking tongue 16 out of its locked position. It is then possible for the locking to be separated owing to the socket and plug parts being drawn away from one another in the axial direction.

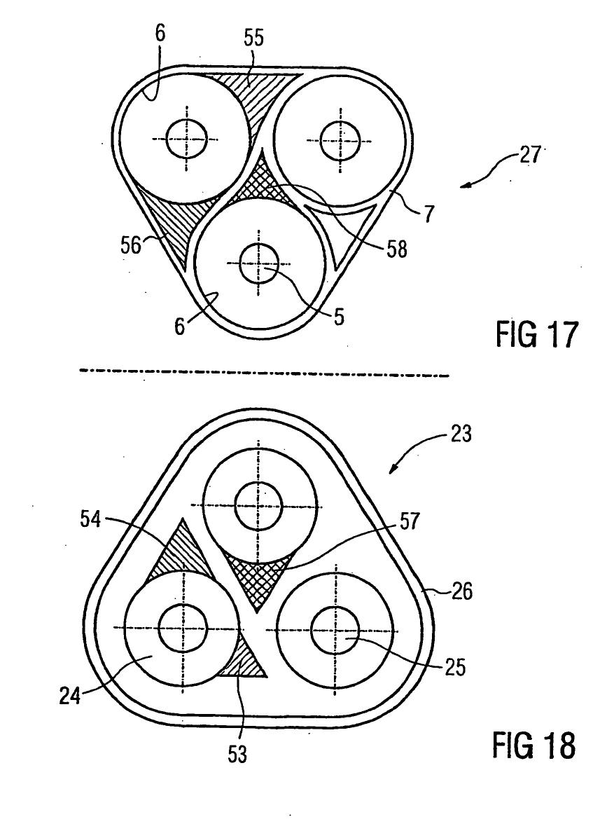

FIGS. 17 and 18 show plug faces 51, 52 of plug contacts associated with one another. In this case, encoding pins 53, 54 which are inserted in corresponding encoding pin recesses 55, 56, in the form of cutouts, in the plug part 27 when the socket part 23 and the plug part 27 are plugged together, are integrally formed on the contact-protection sleeves 24 of the socket contacts 25. In this case, the encoding pins 53, 54 are integrally formed on the contact-protection sleeves 24 of the socket part 23, whereas the contact-protection sleeves 6 of the plug part 27 have corresponding pocket-like extensions 55, 56.

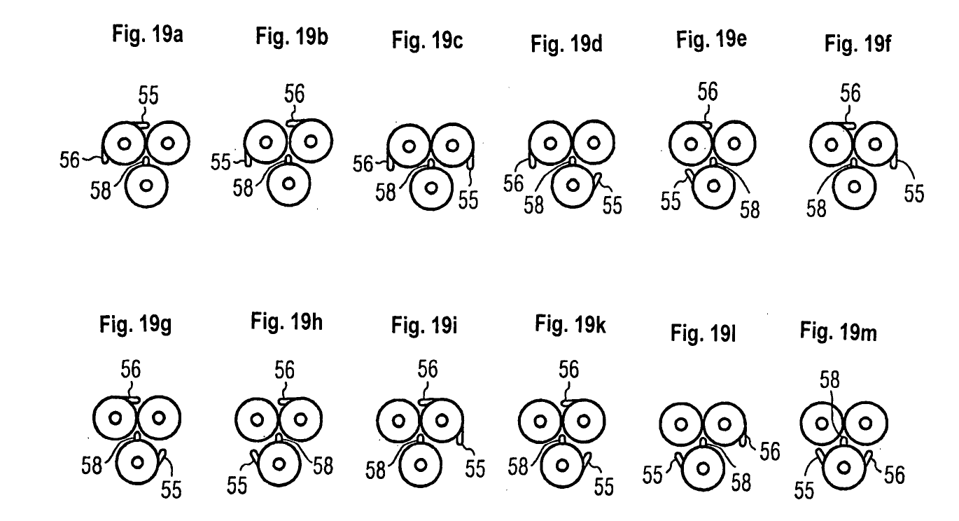

In the case of the three-pole plug-in connector illustrated, there is a total of 12 different encoding possibilities. These are illustrated schematically in FIGS. 19A-19M.

In this case, the variant shown in FIG. 19A corresponds to the plug face shown in FIG. 17. One factor which remains the same in all of the encoding variants is the pin 57, which points in the center point of the three plug-in contacts, on the socket part 23 which, together with a corresponding recess 58 in the plug part 27, provides protection against rotation.

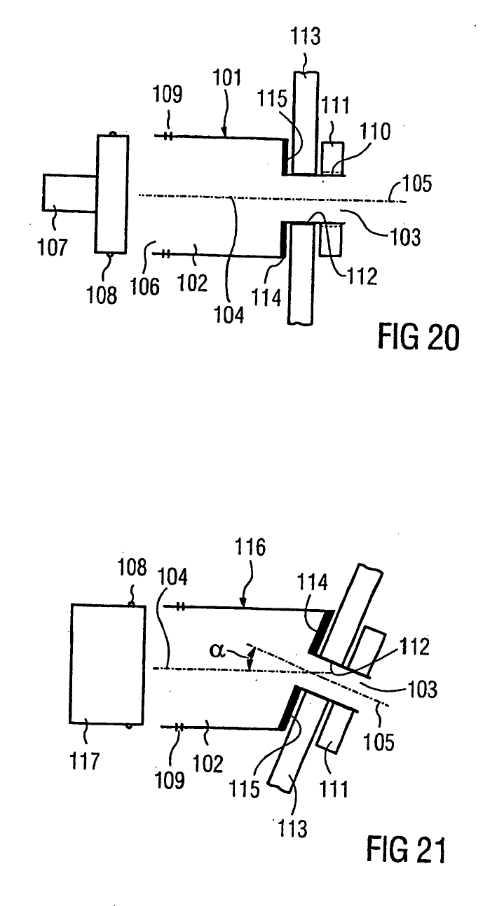

FIG. 20 shows a very simplified sectional view of a two-part device connection plug corresponding to a preferred embodiment of the invention. The device connection plug has all of the features described above which are critical to the invention, as are also illustrated in FIGS. 1 to 6. In addition, the plug-in connector in this embodiment has an adapter element 101 which can be connected to the contact carrier. The adapter element 101 contains a sleeve-like base body 102, for example made from a plastic material, on one side of which there is integrally formed a tubular connection or attachment piece in the form of a bushing connection piece 103. A central longitudinal axis 104 of the base body 102 in this case corresponds to a central longitudinal axis 105 of the bushing connection piece 103, with the result that the bushing connection piece 103 extends in a straight line away from the base body 102. On that side of the base body 102 that lies opposite the bushing connection piece 103, the base body 102 has an accommodating opening 106 for a contact carrier. The contact carrier may be either a plug contact or else a socket contact. By way of example, a schematic illustration of a corresponding plug contact 107 is depicted. The plug contact 107 has, for the purpose of forming a releasable connection, connecting elements in the form of latching tongues 108, which latch into corresponding latching recesses 109 in the base body 102 of the adapter element 101 and, when the contact carrier 107 and the adapter element 101 are joined together, form a secure, mechanical connection. The bushing connection piece 103 is configured to be hollow on the inside, with the result that electrical connection cables can be passed through the bushing connection piece 103 and the base body 102 to the contact carrier 107 and can be connected there to the contact elements of the plug contact. A screw thread 110 is fitted to the outer circumference of the bushing connection piece 103. A fixing nut 111, which is fitted to the bushing connection piece 103, serves the purpose of mounting the adapter element 101 in a housing opening 112 in a housing wall 113. In other words, the adapter element 101 is fixed with its rear side 114, which faces away from the contact carrier 107, to the housing wall 113. In order to ensure effective sealing of the plug-in connection, a round seal 115 is provided which surrounds the bushing connection piece 103 and bears against the base body rear side 114.

Whereas conventional plug-in connector housings are configured, for example, to be mounted in an M 25 mounting opening, the bushing connection piece 103 has a smaller diameter in the exemplary embodiment, with the result that it is also possible for mounting to be performed in a housing opening 112 for M 20 threads (corresponding to PG 13.5).

FIG. 21 shows an again very simplified sectional view of a further exemplary embodiment of an adapter element 101. Here, by way of example, a socket contact 117 is illustrated as the contact carrier to be connected. The adapter element 116 differs from the above-described adapter element 101 by the fact that the bushing connection piece 103 is fitted to the base body 102 of the adapter element 116 such that it is bent back at an angle. The central longitudinal axis 105 of the bushing connection piece 103 encloses, with the central longitudinal axis 104 of the base body 102, an angle a of approximately 30°. Other adapter elements may have a different connection angle in the range from 90° to 180°. Corresponding to the position of the housing opening 112 or the housing wall 113, the rear side 114 of the base body 102 extends at an angle to the base body central axis 104.

This application claims the priority, under 35 U.S.C. § 119, of German patent application No. 102 46 450.2, filed Oct. 4, 2002; the entire disclosure of the prior application is herewith incorporated by reference.

1. An electrical plug-in connector, comprising:
parts to be connected to each other for forming a plug/socket connection having plug-in connectors;
a connection mechanism closing automatically when said parts are joined together;
a contact-protection sleeve; and
a radial seal disposed on said contact-protection sleeve, for sealing said parts connected to one another, in a region of overlap between said plug-in connectors connected to one another.

2. The electrical plug-in connector according to claim 1, wherein said connection mechanism contains a locking tongue having at least one latching hook pointing in a plug-in direction, said locking tongue for fitting into a locking opening.

3. The electrical plug-in connector according to claim 1, further comprising a mounting element for fixing the electrical plug-in connector to a device wall.

4. The electrical plug-in connector according to claim 3, further comprising an axial seal disposed on said mounting element.

5. The electrical plug-in connector according to claim 1, further comprising an adapter element having a bushing connection piece for passing through a housing opening, said adapter element further having a connection element for forming a connection with a contact carrier, said bushing connection piece having outer dimensions which are different from those of a rest of said adapter element.

6. The electrical plug-in connector according to claim 1,
further comprising a further connection mechanism;
further comprising a further radial seal; and
wherein said parts include a strain-relief device and a contact carrier, said further connection mechanism closes automatically when said strain-relief device and said contact carrier are joined together, for connecting said contact-carrier to said strain-relief device and said further radial seal sealing said strain-relief device to said contact carrier.

7. The electrical plug-in connector according to claim 6, wherein said strain-relief device can be pushed onto said contact carrier, and said further radial seal is disposed in a region of overlap between said strain-relief device and said contact carrier.

8. The electrical plug-in connector according to claim 6, wherein said further connection mechanism has latching elements fitted on said contact carrier and said strain-relief device.

9. The electrical plug-in connector according to claim 1, wherein said connection mechanism can only be opened using an actuating tool.

10. The electrical plug-in connector according to claim 1, wherein said radial seal is disposed such that, when said connection mechanism is released, even a very short release path is sufficient for overcoming frictional forces of said radial seal.

11. The electrical plug-in connector according to claim 1, further comprising an opener for opening said connection mechanism.

12. The electrical plug-in connector according to claim 11, wherein said opener is connected on the electrical plug-in connector such that said opener can be released.

13. The electrical plug-in connector according to claim 11, wherein said opener has an actuating element and an release element fixed to said actuating element which can be deflected, for opening said connection mechanism.

14. The electrical plug-in connector according to claim 1, further comprising a plug-in contact and said contact-protection sleeve being associated with said plug-in contact, said plug-in contact having a pocket-shaped or web-shaped anti-rotation element.

15. The electrical plug-in connector according to claim 1,
wherein said plug-in contact is one of a plurality of plug-in contacts;
wherein said contact-protection sleeve is one of a plurality of contact-protection sleeves, each of said plug-in contacts has one of said contact-protection sleeves;
further comprising at least one pocket-shaped or web-shaped encoding element associated with at least one of said contact-protection sleeves.

16. The electrical plug-in connector according to claim 15, wherein said encoding element is one of a plurality of encoding elements and at least one of said encoding elements points in a direction of said contact-protection sleeve which is disposed on a further contact plane.

17. The electrical plug-in connector according to claim 12, wherein said opener forms a latching connection.

18. The electrical plug-in connector according to claim 6, wherein said further connection mechanism can only be opened using an actuating tool.

19. The electrical plug-in connector according to claim 6, wherein said further radial seal is disposed such that, when said further connection mechanism is released, even a very short release path is sufficient for overcoming frictional forces of said further radial seal.

20. The electrical plug-in connector according to claim 6, further comprising an opener for opening said further connection mechanism.

21. The electrical plug-in connector according to claim 20, wherein said opener is connected on the electrical plug-in connector such that said opener can be released.

22. The electrical plug-in connector according to claim 20, wherein said opener has an actuating element and an release element fixed to said actuating element which can be deflected, for opening said further connection mechanism.

23. An electrical plug-in connector, comprising:
a connection mechanism closing automatically when parts to be connected are joined together for forming a plug/socket connection with a further plug-in connector; and
a radial seal disposed on a contact-protection sleeve of one of the parts, for sealing the parts connected to one another, in a region of overlap between the electrical plug-in connector and the further plug-in connector connected to one another.

24. The electrical plug-in connector according to claim 23, wherein said connection mechanism contains a locking tongue having at least one latching hook pointing in a plug-in direction, said locking tongue for fitting into a locking opening.

25. The electrical plug-in connector according to claim 23, further comprising a mounting element for fixing the electrical plug-in connector to a device wall.

26. The electrical plug-in connector according to claim 25, further comprising an axial seal disposed on said mounting element.

27. The electrical plug-in connector according to claim 23, further comprising an adapter element having a bushing connection piece for passing through a housing opening, said adapter element further having a connection element for forming a connection with a contact carrier, said bushing connection piece having outer dimensions which are different from those of a rest of said adapter element.

28. The electrical plug-in connector according to claim 23,
further comprising a further connection mechanism;
further comprising a further radial seal; and
wherein the parts include a strain-relief device and a contact carrier, said further connection mechanism closes automatically when the strain-relief device and the contact carrier are joined together, for connecting the contact carrier to the strain-relief device and said further radial seal sealing the strain-relief device to the contact carrier.

29. The electrical plug-in connector according to claim 28, wherein the strain-relief device can be pushed onto the contact carrier, and said further radial seal is disposed in a region of overlap between the strain-relief device and the contact carrier.

30. The electrical plug-in connector according to claim 28, wherein said further connection mechanism has latching elements fitted on the contact carrier and the strain-relief device.

31. The electrical plug-in connector according to claim 23, wherein said connection mechanism can only be opened using an actuating tool.

32. The electrical plug-in connector according to claim 23, wherein said radial seal is disposed such that, when said connection mechanism is released, even a very short release path is sufficient for overcoming frictional forces of said radial seal.

33. The electrical plug-in connector according to claim 23, further comprising an opener for opening said connection mechanism.

34. The electrical plug-in connector according to claim 33, wherein said opener is connected on the electrical plug-in connector such that said opener can be released.

35. The electrical plug-in connector according to claim 33, wherein said opener has an actuating element and an release element fixed to said actuating element which can be deflected, for opening said connection mechanism.

36. The electrical plug-in connector according to claim 23, further comprising a plug-in contact and the contact-protection sleeve being associated with said plug-in contact, said plug-in contact having a pocket-shaped or web-shaped anti-rotation element.

37. The electrical plug-in connector according to claim 23,
wherein said plug-in contact is one of a plurality of plug-in contacts;
wherein the contact-protection sleeve is one of a plurality of contact-protection sleeves, each of said plug-in contacts has one of the contact-protection sleeves;
further comprising at least one pocket-shaped or web-shaped encoding element associated with at least one of the contact-protection sleeves.

38. The electrical plug-in connector according to claim 37, wherein said encoding element is one of a plurality of encoding elements and at least one of said encoding elements points in a direction of the contact-protection sleeve which is disposed on a further contact plane.
